(19) United States
(12) Patent Application Publication
(10) Pub. No.: US 2012/0017817 A1
(43) Pub. Date: Jan. 26, 2012

(54) Solar powered mooring cleat

(76) Inventor: Jeffrey Scott Martzall, Fort Wayne, IN (US)

(21) Appl. No.: 12/804,323

(22) Filed: Jul. 20, 2010

(51) Int. Cl. B63B 21/04; F21L 4/08

(52) U.S. Cl. 114/218; 362/183

(57) ABSTRACT

A durable metal mooring cleat with a caged in and protected illumination source such as a solar lighting unit. The cleat body is designed with openings on top and sides to allow light to project from the illumination source. There is at least one access panel which allows persons easy access to the solar lighting unit without having to detach the cleat body from the surface mounted thereon. The access panel has an opening to allow visibility of the illumination source and sunlight to a solar panel. The solar powered mooring cleat provides fast installation without costly wiring or electrical cost as well it is conveniently designed for easy serviceability. The illumination provided at night makes it easily visible from all angles and thus adds to the safety of persons and watercraft operating around them.

### CROSS REFERENCE TO RELATED APPLICATIONS

Not Applicable

### FEDERALLY SPONSORED RESEARCH OR DEVELOPMENT

Not Applicable

### DESCRIPTION OF THE ATTACHED APPENDIX

Not Applicable

### BACKGROUND OF THE INVENTION—FIELD OF INVENTION

This invention relates generally to the field of marine dock hardware and more specifically to a Dock Cleat with the ability to provide illumination for visibility at night. Dock and Piers have low visibility during the night and mooring cleats become hazards to persons walking or operating around them. Mooring cleats are used around the perimeter of docks to provide a means to secure watercraft using ropes, lines, or cables. At night, mooring cleats are difficult to see and are dangerous for persons walking near them. Mooring Cleats protrude above the dock surface and if not seen, can cause a person to trip. Since mooring cleats are difficult to see at night, they could cause a person to stumble into the water, resulting in serious injury or death. Piers and docks are located over water which makes current electrically powered cleats dangerous and costly to operate.

### BACKGROUND OF THE INVENTION—PRIOR ART

Thereafter, inventors created various methods for lighting cleats making them visible at night. U.S. Pat. No. 5,216,972 to Dufrene & Deed (1993) is a lighted dock cleat; however, this lighted cleat is molded as one piece from translucent polyurethane which can be easily broken by the forces watercraft typically exert on the unit. A translucent cleat is difficult to see even during daylight hours as it blends in with the dock surface and poses a daytime safety hazard. Non metal cleats are discouraged from usage because they present a liability and safety issue when broken. When broken, the boat can become detached from the dock and float away, possibly resulting in damage or liability. This lighted cleat has solar cells in the horns of the cleat which make internal wiring more difficult for production methods. Solar panels are fragile and this design does not offer recessed protection from the ropes and abrasion may lead to damage of the solar panels. The light emitting diodes are placed so that they shine upward and outward which does not project enough light to the side or onto the dock surface. Watercraft approach the dock from the side and thus desire more light from the side. Upward illumination furthermore does not provide illumination onto the dock surface where it is needed. Upward illumination can be dangerous for persons walking nearby as the direct light may enter the eye impairing immediate night time vision. Vision impairment on a dock near water at night is a safety hazard.

Additionally, this cleat is not easily accessible or serviceable. The access panel is inconveniently placed on the bottom of the cleat. This requires persons to detach the cleat from the dock surface. Detaching cleats from the dock often requires persons to be under the dock or in the water for servicing. This is not practical and often impossible depending on the season, water temperatures, or dock layout. A bottom access panel requires extensive labor and can result in significant cost, especially for marinas with hundreds of cleats.

U.S. Pat. No. 6,968,796 to Burke (2005) is a lighted cleat with top only groove to affix an illumination source either of trinium gas or light emitting diodes. This design requires electrical power and is not easily installed by average persons. This unit requires persons to outfit electrical wires and lines to the unit. Mooring cleats are typically placed on docks over water; electrical power can be dangerous to the installer and end user. Furthermore, due to the danger associated with electrical lines in wet environments, a licensed electrician is often required for installation of such devices. This adds significantly to the installation cost not to mention the operating electrical cost of each fixture. This mooring cleat with illumination can only direct light upward and outward from the light source. The groove in which the light source rest does not have a through hole and thus cannot project light downward on the dock surface where it can prove useful and easier on the eyes. It is also difficult to be seen by watercraft that are approaching from the side at a lower elevation than the cleat. Since light is only directed upward and outward persons walking near the cleat can be distracted by the direct light entering their eye thus impairing immediate night time vision. One variation of this design is equipped with numerous light emitting diodes shinning directly upward. Due to the intense directional brightness of light emitting diodes it is not safe to look directly into their light as it may impair vision.

### BACKGROUND OF THE INVENTION—OBJECTS AND ADVANTAGES

The primary objective of the invention is to provide a durable mooring cleat to protect an integrated yet independent solar lighting unit which provides outward illumination for the mooring cleat.

Another object of the invention is to provide a mooring cleat with an access panel for easily accessing, servicing, and replacing a solar lighting unit which does not require replacement of the entire product in the event a part becomes damaged.

Another object of the invention is to provide a solar lighting unit which is recessed from the cleat body to help protect it from the forces of ropes, cables, or lines, and the damages they may cause to the solar lighting unit.

Another object of the invention is to provide a solar lighting unit which is not permanently affixed to the mooring cleat.

Yet another object of the invention is to provide a mooring cleat that does not require detachment from the dock surface mounted thereon to change the solar lighting unit or embodied components.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a mooring cleat which embodies a solar lighting unit comprising; A mooring cleat with specially designed body to incorporate separate solar lighting unit; A mooring cleat body which protects the separate solar lighting unit from the forces of mooring ropes or lines; A mooring cleat which does not need to detach from the surface mounted thereon to access or change the solar lighting unit or its embodied components; A solar lighting unit encapsulated by a translucent housing; A solar panel to collect energy; A Battery to store energy; A Light Emitting Diode to generate light; A circuit to designate how energy is collected and used.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 A perspective view of the top of a solar powered mooring cleat with visible solar panel, mooring cleat access panel, and solar lighting unit lens.

FIG. 2 A exploded view of a solar powered mooring cleat with visible mooring cleat, solar lighting unit reflector, solar lighting unit housing lens, and mooring cleat access panel.

FIG. 3 Illustrates a top view of a solar powered mooring cleat with visible solar panel & mooring cleat access panel.

FIG. 4 Illustrates an end view of a solar powered mooring cleat.

FIG. 5 Illustrates a side view of a solar powered mooring cleat with visible lens.

FIG. 6 Illustrates a bottom view of a solar powered mooring cleat with visible bolt cavity holes.

FIG. 7 Illustrates a sectional view of a solar powered mooring cleat with visible bolt cavities and solar lighting unit.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### THIS IS THE DETAILED DESCRIPTION OF THE UNIT

A solar powered mooring cleat comprising of a durable metal mooring cleat body capable of withstanding the forces ropes and their attachments exert on them. The solar powered mooring cleat has a separate integrated solar powered lighting unit which illuminates outward from the cleat through visible top and side openings that have been designed into the body of the cleat. The solar powered lighting unit's reflector projects light outward through the lens and the mooring cleat body openings.

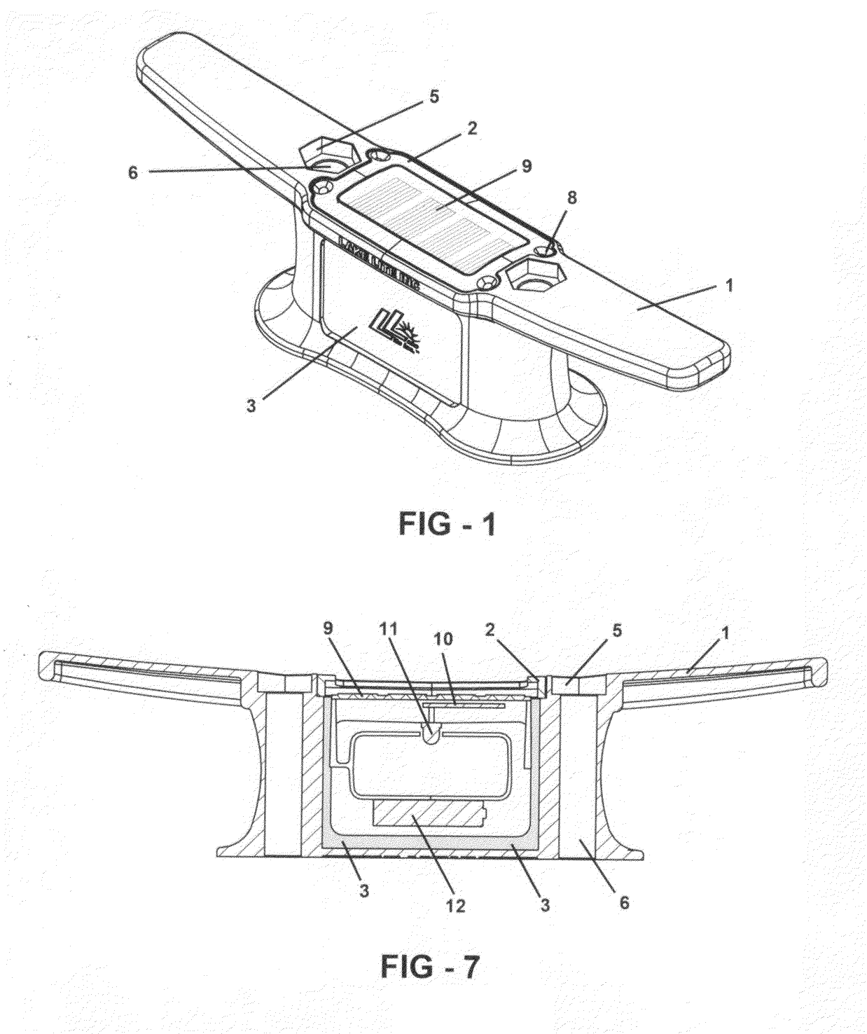

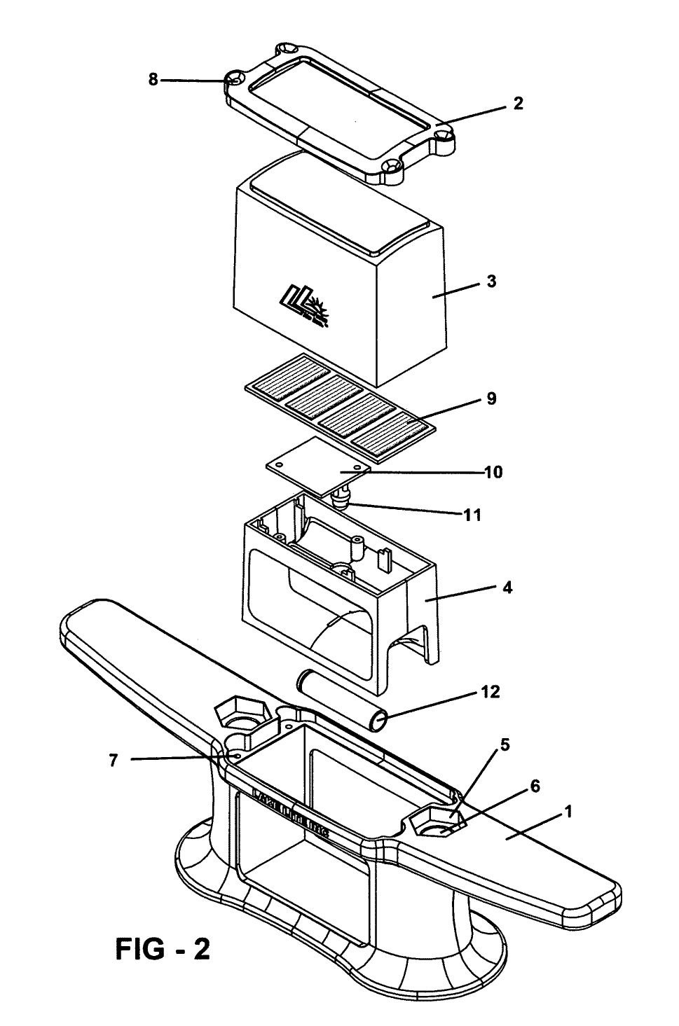

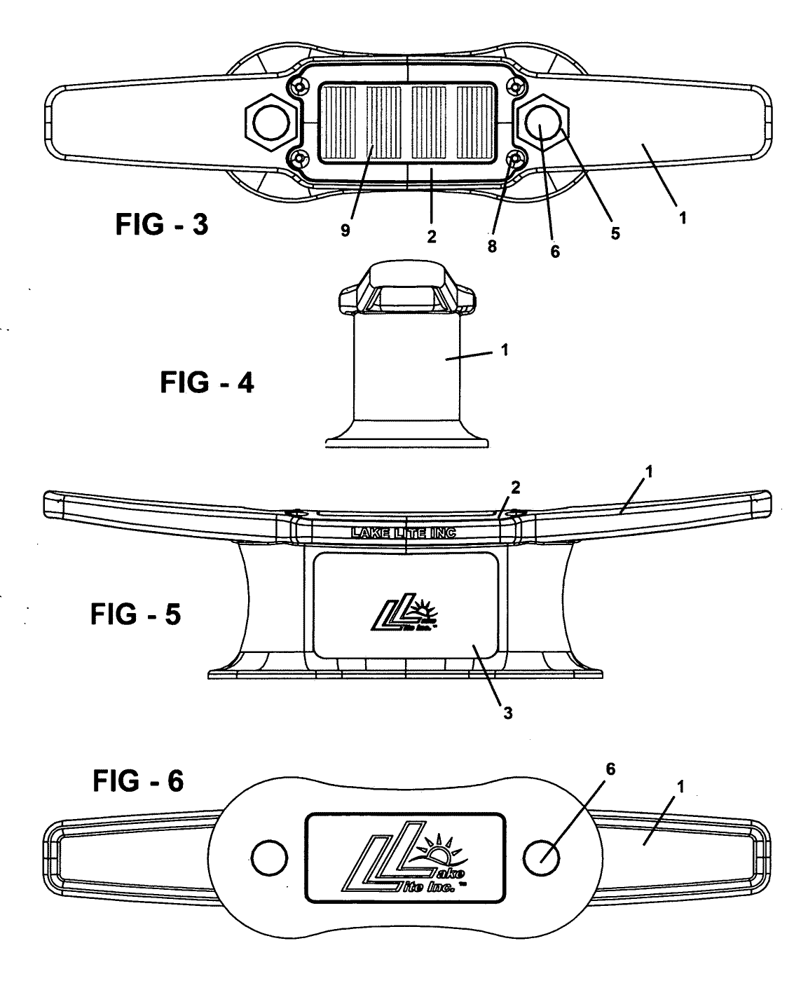

Referring to FIGS. 1 through 7, a molded durable metal mooring cleat body (1) with top access panel (2) allowing easy access to a solar powered lighting unit. Top access panel (2) consists of a recessed bolt head cavity (8) so that a connecting bolt or screw will be flush with the top most portion of top access panel (2). Mooring cleat body (1) has threaded holes (7) for joining top access panel (2) with a bolt or screw.

The mooring cleat (1) consists of mounting features for bolting the device to a dock or surface through a recessed bolt head cavity (5) and a through hole cylinder cavity (6). The recessed bolt head cavity (5) allows the head of a bolt to be flush with the top most portion of mooring cleat body (1). The recessed bolt head cavity (5) also keeps a bolt stationary while a mounting bolt nut is fastened. The recessed bolt head Cavity (5) can be designed to match the head of many types of fastening devices such as bolts, screws, carriage bolts, or other similar hardware.

The solar powered lighting unit consist of a translucent housing lens (3) which houses a reflector (4) for maximizing light output through mooring cleat body (1) openings, a solar cell (9) for collecting energy from the sun and a storage cell (12) for storing energy collected from the solar cell (9), a circuit board (10) to designate how power is stored from solar panel (9), and how power is released from storage cell (12) to a light emitting diode (11). The circuit board (10) also controls the function of turning the light emitting diode (11) on at sunset and off at sunrise. Circuit board (10) also controls the brightness of light emitting diode (11). Furthermore circuit board (10) protects storage cell (12) from being overcharged by solar panel (9) as well circuit board (10) protects the light emitting diode (11) from over discharging storage cell (12).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A mooring cleat comprising a body with openings on top and sides where an embodied illumination source can emit and project light outward from said openings and at least one access panel to allow easy access and serviceability to said illumination source without detaching said cleat body from the surface mounted thereon.

2. A mooring cleat as set forth in claim 1 wherein said access panel is removable securable to said body and allows visibility of said illumination source.

3. A mooring cleat as set forth in claim 1 wherein said access panel does not interfere with mounting hardware that attaches said body to said surface mounted thereon.

4. A mooring cleat as set forth in claim 1 wherein said body is designed to cage in and protect said illumination source from the forces of ropes or lines attached to said body.

5. A mooring cleat as set forth in claim 1 wherein said body and said access panel is constructed of metal material.

6. A mooring cleat as set forth in claim 1 wherein a solar lighting unit may exist within said body providing a method for said illumination source emitting and projecting light through said windows.

7. A mooring cleat as set forth in claim 1 wherein said access panel allows a solar panel direct access or visibility to sunlight.

8. A mooring cleat as set forth in claim 1 wherein said illumination source is said solar lighting unit, comprising:
(a.) A housing lens constructed of translucent material.
(b.) A reflector to maximize light outward from said openings in said body
(c.) Wherein said solar panel is connected to a circuit board which is connected to both a storage cell and light emitting diode.

9. A mooring cleat as set forth in claim 1 wherein said illumination source is a self contained.

10. A mooring cleat as set forth in claim 1 wherein said illumination source is recessed from said body to help protect said illumination source from said ropes or said lines attached to said body.
